(19) United States
(12) Patent Application Publication
(10) Pub. No.: US 2022/0281459 A1
(43) Pub. Date: Sep. 8, 2022

(54) AUTONOMOUS DRIVING COLLABORATIVE SENSING

(71) Applicant: Black Sesame International Holding Limited, Santa Clara, CA (US)

(72) Inventor: Yu Huang, Sunnyvale, CA (US)

(73) Assignee: Black Sesame International Holding Limited

(21) Appl. No.: 17/193,886

(22) Filed: Mar. 5, 2021

(51) Int. Cl. B60W 40/04; G06T 9/00; G06T 7/70

(52) U.S. Cl. CPC B60W 40/04; G06T 9/007; G06T 7/70; B60W 2420/52; B60W 2420/42; B60W 2556/40; B60W 2556/45; G06T 2207/30252

(57) ABSTRACT

A method of autonomous driving collaborative sensing, including receiving at least one sensor input, determining a pose based on the at least one sensor input, synchronizing the at least one sensor input to the pose, transforming the at least one sensor input, the pose and the synchronization, determining an intermediate representation based on the transform, determining an object extraction based on the transform, aggregating the at least one sensor input, the intermediate representation and the object extraction and determining a birds eye view of the aggregation.

### BACKGROUND

### Technical Field

The instant disclosure is related to autonomous driving and more specifically to collaborative sensing for autonomous driving.

### Background

Currently, methods of autonomous driving are single vehicle, termed ego vehicle based. This leads to a sensor island approach to driving in which the ego vehicle is an island unto itself and does not allow the ego vehicle the benefits of viewing driving conditions from outside itself. This sensor island approach, may lead to a very limited vantage point and not give the vehicle additional time to consider a driving situation.

### SUMMARY

An example method of autonomous driving collaborative sensing, including receiving at least one sensor input, determining a pose based on the at least one sensor input, synchronizing the at least one sensor input to the pose, transforming the at least one sensor input, the pose and the synchronization, determining an intermediate representation based on the transform, determining an object extraction based on the transform, aggregating the at least one sensor input, the intermediate representation and the object extraction and determining a birds eye view of the aggregation.

Another example method of autonomous driving collaborative sensing, including receiving at least one sensor input, determining a pose based on the at least one sensor input, synchronizing the at least one sensor input to the pose, transforming the at least one sensor input, the pose and the synchronization, determining an object extraction based on the transform, aggregating the at least one sensor input and the object extraction, detecting the extracted object, segmenting the extracted object, fusing the detected and segmented object and determining a birds eye view of the aggregation.

### DESCRIPTION OF THE DRAWINGS

In the drawings:

FIG. 1 is a first example system diagram in accordance with one embodiment of the disclosure;

FIG. 2 is a second example system diagram in accordance with one embodiment of the disclosure;

FIG. 3 is an example V2X (vehicle to everything) sensing system in accordance with one embodiment of the disclosure;

FIG. 4 is an example of V2X sensor fusion in accordance with one embodiment of the disclosure;

FIG. 5 is an example of vehicle localization without and HD (High Definition) map for sensor fusion in V2X in accordance with one embodiment of the disclosure;

FIG. 6 is an example of vehicle localization with an HD map for sensor fusion in V2X in accordance with one embodiment of the disclosure;

FIG. 7 is an example of a road sensor network in V2X in accordance with one embodiment of the disclosure;

FIG. 8 is a first example method in accordance with one embodiment of the disclosure; and

FIG. 9 is a second example method in accordance with one embodiment of the disclosure.

### DETAILED DESCRIPTION OF THE INVENTION

The embodiments listed below are written only to illustrate the applications of this apparatus and method, not to limit the scope. The equivalent form of modifications towards this apparatus and method shall be categorized as within the scope the claims.

Certain terms are used throughout the following description and claims to refer to particular system components. As one skilled in the art will appreciate, different companies may refer to a component and/or method by different names. This document does not intend to distinguish between components and/or methods that differ in name but not in function.

In the following discussion and in the claims, the terms “including” and “comprising” are used in an open-ended fashion, and thus may be interpreted to mean “including, but not limited to . . . .” Also, the term “couple” or “couples” is intended to mean either an indirect or direct connection. Thus, if a first device couples to a second device that connection may be through a direct connection or through an indirect connection via other devices and connections.

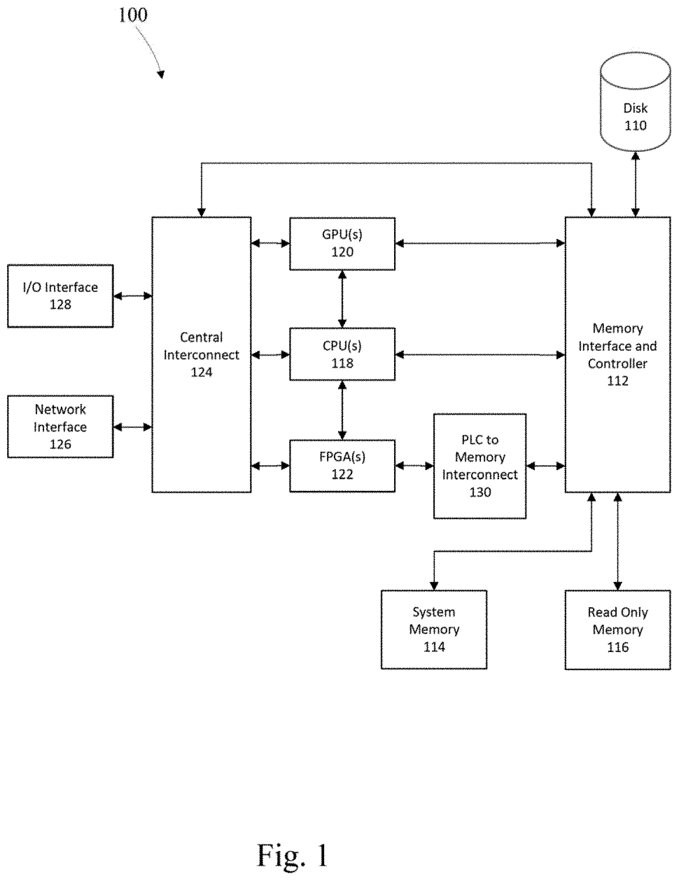

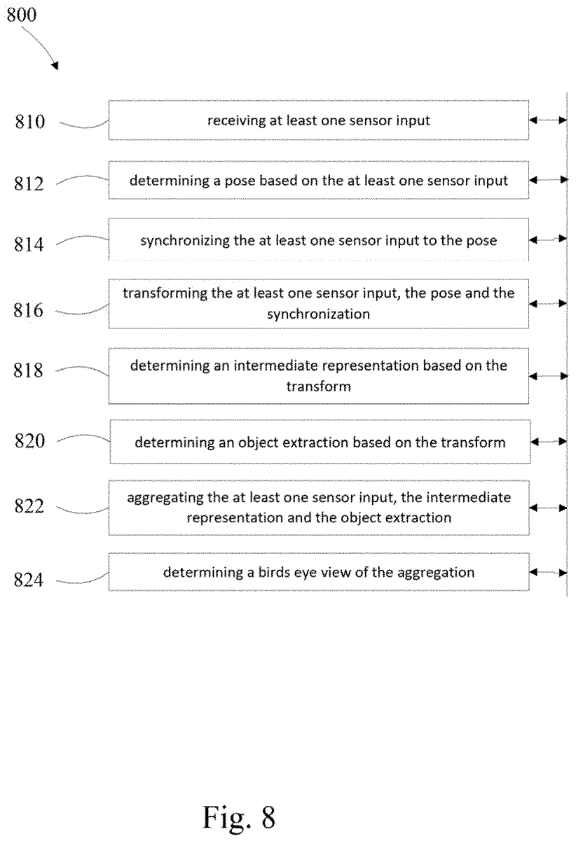

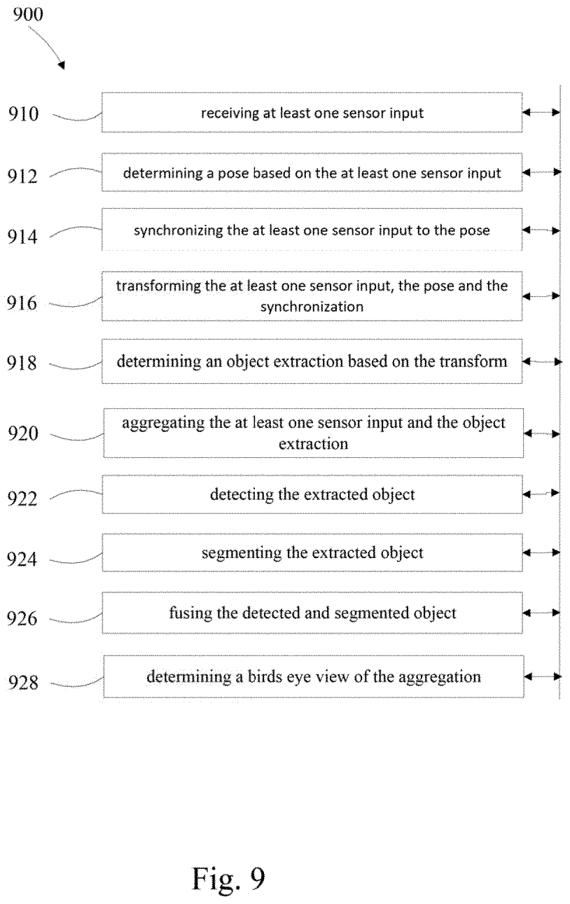

FIG. 1 depicts an example hybrid computational system 100 that may be used to implement neural nets associated with the operation of one or more portions or steps of the processes depicted in FIGS. 8-9. In this example, the processors associated with the hybrid system comprise a field programmable gate array (FPGA) 122, a graphical processor unit (GPU) 120 and a central processing unit (CPU) 118.

The CPU 118, GPU 120 and FPGA 122 have the capability of providing a neural net. A CPU is a general processor that may perform many different functions, its generality leads to the ability to perform multiple different tasks, however, its processing of multiple streams of data is limited and its function with respect to neural networks is limited. A GPU is a graphical processor which has many small processing cores capable of processing parallel tasks in sequence. An FPGA is a field programmable device, it has the ability to be reconfigured and perform in hardwired circuit fashion any function that may be programmed into a CPU or GPU. Since the programming of an FPGA is in circuit form, its speed is many times faster than a CPU and appreciably faster than a GPU.

There are other types of processors that the system may encompass such as an accelerated processing unit (APUs) which comprise a CPU with GPU elements on chip and digital signal processors (DSPs) which are designed for performing high speed numerical data processing. Application specific integrated circuits (ASICs) may also perform the hardwired functions of an FPGA; however, the lead time to design and produce an ASIC is on the order of quarters of a year, not the quick turn-around implementation that is available in programming an FPGA.

The graphical processor unit 120, central processing unit 118 and field programmable gate arrays 122 are connected and are connected to a memory interface controller 112. The FPGA is connected to the memory interface through a programmable logic circuit to memory interconnect 130. This additional device is utilized due to the fact that the FPGA is operating with a very large bandwidth and to minimize the circuitry utilized from the FPGA to perform memory tasks. The memory and interface controller 112 is additionally connected to persistent memory disk 110, system memory 114 and read only memory (ROM) 116.

The system of FIG. 1A may be utilized for programming and training the FPGA. The GPU functions well with unstructured data and may be utilized for training, once the data has been trained a deterministic inference model may be found and the CPU may program the FPGA with the model data determined by the GPU.

The memory interface and controller is connected to a central interconnect 124, the central interconnect is additionally connected to the GPU 120, CPU 118 and FPGA 122. The central interconnect 124 is additionally connected to the input and output interface 128 and the network interface 126.

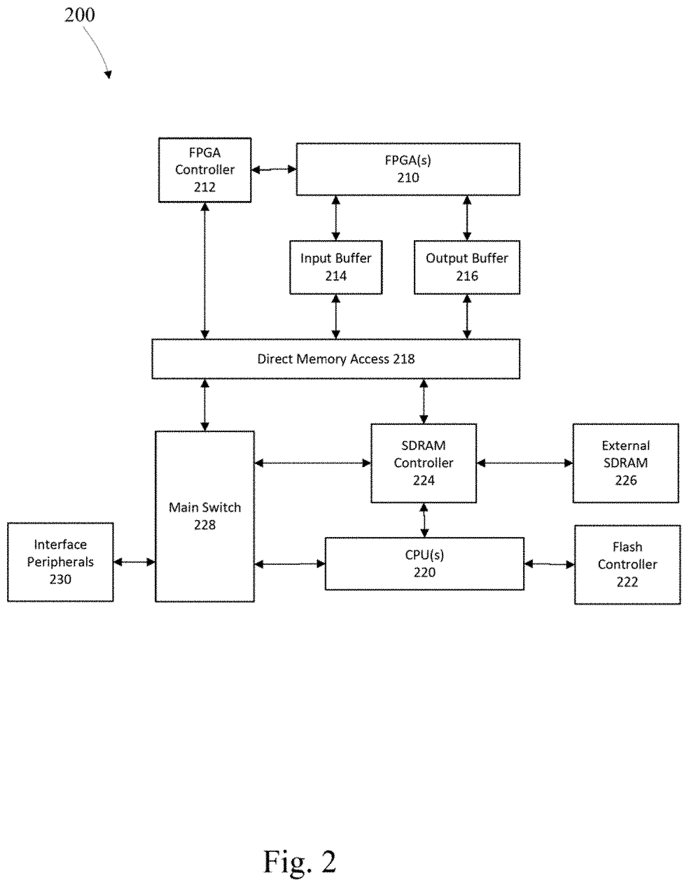

FIG. 2 depicts a second example hybrid computational system 200 that may be used to implement neural nets associated with the operation of one or more portions or steps of process 1000. In this example, the processors associated with the hybrid system comprise a field programmable gate array (FPGA) 210 and a central processing unit (CPU) 220.

The FPGA is electrically connected to an FPGA controller 212 which interfaces with a direct memory access (DMA) 218. The DMA is connected to input buffer 214 and output buffer 216, which are coupled to the FPGA to buffer data into and out of the FPGA respectively. The DMA 218 includes of two first in first out (FIFO) buffers one for the host CPU and the other for the FPGA, the DMA allows data to be written to and read from the appropriate buffer.

On the CPU side of the DMA are a main switch 228 which shuttles data and commands to the DMA. The DMA is also connected to an SDRAM controller 224 which allows data to be shuttled to and from the FPGA to the CPU 220, the SDRAM controller is also connected to external SDRAM 226 and the CPU 220. The main switch 228 is connected to the peripherals interface 230. A flash controller 222 controls persistent memory and is connected to the CPU 220.

V2X (vehicle to everything) is a vehicular technology system that enables vehicles to communicate with the traffic and the environment around them, including vehicle-to-vehicle communication (V2V) and vehicle-to-infrastructure (V2I). By accumulating detailed information from peers, drawbacks of the ego vehicle such as sensing range and blind spots may be reduced.

V2X allows the transferring of information from other vehicles or road side devices to enhance the perception capability of the ego vehicle. The transference may take into consideration time delay and spatial pose differences. V2V perception will consider an on-vehicle sensor data processing agent. An example is a vehicle in front of the ego vehicle which may perceive the scene unseen to the ego vehicle and share the detected information, such as the lanes, traffic signs and obstacles.

Vehicle-to-infrastructure processes sensor data captured from roadside, for example at the cross intersection so that a roadside perception may share the traffic signal, road lane information and vehicle/pedestrian status.

In vehicle-to-everything, a vehicle On-Board Unit (OBU) or On-Board Equipment (OBE) may include an antenna, a location system, a processor, a vehicle operation system and a HMI (human machine interface).

A Roadside Unit (RSU) or Roadside Equipment (RSE) may include an antenna, a location system, a processor, a vehicle infrastructure interface and other interfaces.

Vehicle-to-everything sensing may be similar to that in autonomous driving and additionally include sensors at the roadside which may be static or moving. The sensors at the roadside may have a higher pose to watch a broader view and avoid a large of occlusions happened at the ego vehicle, may be unconstrained by vehicle regulation and cost. Additionally, edge computing at the roadside may provide a computing platform exceeding that of the ego vehicle.

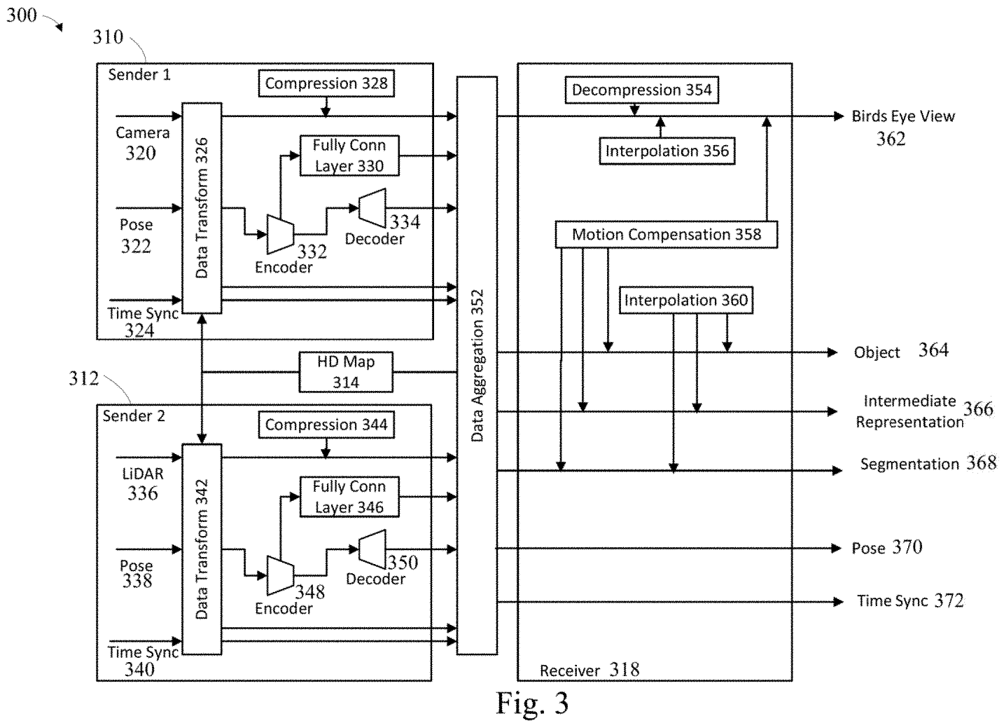

Shown in FIG. 3, the temporal considerations may include the time difference between data received from different agents. The instant system may include a data container having a temporal window, for example, 1 second, 10 frames for LiDAR (Light Detection and Ranging)/radar and 30 frames for camera. Pose data may be included for spatial registration, acquired from vehicle localization and based on matching with information in an HD (High Definition) IMU (Inertial Measurement Unit) map.

FIG. 3 depicts an example vehicle to everything sensing system including a sender module 1 310, includes an input from a camera 320, input for pose 322 and an input for time synchronization 324. The sender module 1 includes a data transform module 326 coupled to an encoder 332 which in turn is connected to a decoder 334 and a fully connected layer 330. The data transform module 326 is also connected via a compression module 328 to a data aggregation module 352.

A sender module 2 312 includes an input from a LiDAR 336, input for pose 3338 and an input for time synchronization 340. The sender module 2 includes a data transform module 342 coupled to an encoder 348 which in turn is connected to a decoder 350 and a fully connected layer 348. The data transform module 342 is also connected via a compression module 344 to the data aggregation module 352.

Both the data transform module 326 and 342 are connected to a high density map 314 which in turn is connected to the data aggregation module 352.

The data aggregation module 352 is connected to receiver 318 having decompression 354 and interpolation 356 leading to a birds eye view output 362. A motion compensation module 358 is connected to an object output 364, intermediate representation 366 and segmentation 368. The data aggregation module 352 is routed through the receiver to output a pose 370 and time synchronization 372.

The ego vehicle sensors may include cameras and LiDARs. The neural network model may process the raw data to output intermediate representation (IR), scene segmentation and object detection. To unify a fusion space, the raw data may be mapped to a BEV (bird eye view) and processed results may be registered in the same space.

Modules marked as compression and decompression may be utilized for raw data, modules interpolation and motion compensation may be utilized at the receiver based on the time synchronization signal and relative pose based on the HD Map and ego vehicle localization. To keep a limited scale space, multiple layers in IR may be reserved, such as 3, which may allow an increase in flexible fusion of different data resolution for instance, 16, 32 or 64 scanning lines in mechanic LiDAR sensor.

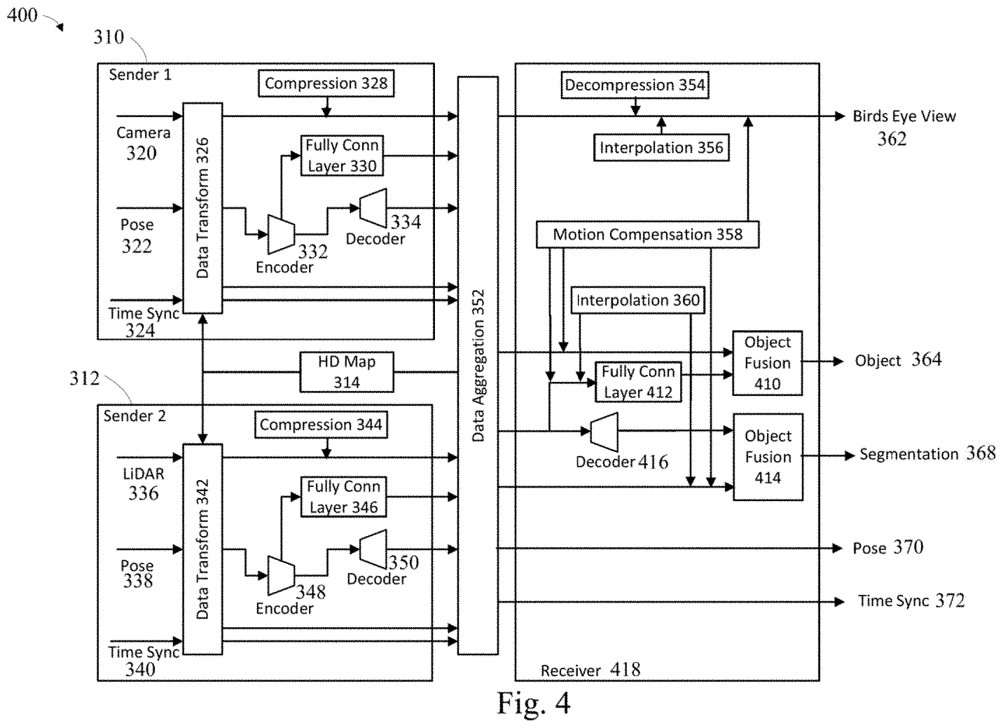

FIG. 4 depicts another example vehicle to everything sensing system including sender module 1 310, includes an input from a camera 320, input for pose 322 and an input for time synchronization 324. The sender module 1 includes a data transform module 326 coupled to an encoder 332 which in turn is connected to a decoder 334 and a fully connected layer 330. The data transform module 326 is also connected via a compression module 328 to a data aggregation module 352.

A sender module 2 312 includes an input from a LiDAR 336, input for pose 338 and an input for time synchronization 340. The sender module 2 includes a data transform module 342 coupled to an encoder 348 which in turn is connected to a decoder 350 and a fully connected layer 348. The data transform module 342 is also connected via a compression module 344 to the data aggregation module 352.

Both the data transform module 326 and 342 are connected to a high density map 314 which in turn is connected to the data aggregation module 352.

The data aggregation module 352 may be connected to receiver 418 having decompression 354 and interpolation 356 leading to a birds eye view output 362. A motion compensation module 358 is connected to the birds eye view output 362 an object fusion module 410 a fully connected layer 412 and an object fusion for segmentation module 414 outputting object 364. An interpolation module 360 may be connected to the fully connected layer 412, and the object fusion for segmentation module 414 outputting segmentation 368. The data aggregation module 352 may be routed through the receiver to output a pose 370 and time synchronization 372.

FIG. 4 illustrates the V2X fusion, where IR, segmentation and detection channels are fused respectively. Raw data may be fused at the receiver side by module Motion Compensation and module Interpolation. Meanwhile IR may be sent to a neural network to generate object-level results. The object-level results such as detection and segmentation may be fused in module Object Fusion.

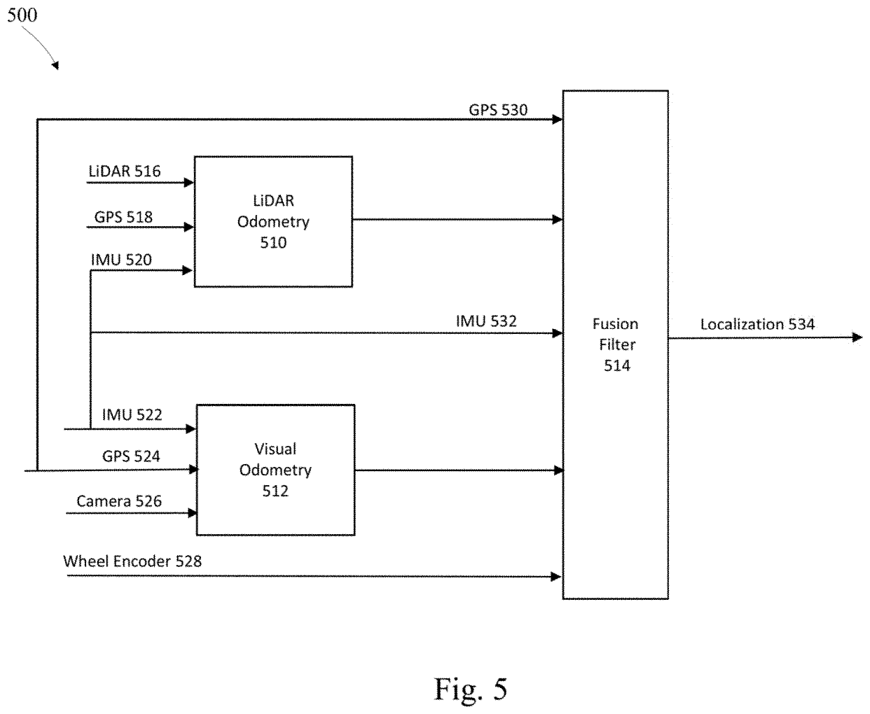

The HD Map-based localization for V2X sensor fusion may be utilized. It may be beneficial to utilize a sensor fusion framework to handle sensor shortcomings and utilize the information. FIG. 5 depicts a sensor fusion framework of vehicle localization without an HD Map. LiDAR and camera odometry may work with GPS (Global Positioning System)/IMU (Inertial Measurement Unit)/wheel encoder to a fusion filter such as Kalman filter or Particle filter. LiDAR odometry may utilize point cloud matching to estimate the vehicle motion. Visual odometry may apply either a direct method such as image-based, a feature-based method such as feature extraction and matching and a semi-direct method such as edge and/or gradient.

FIG. 5 depicts vehicle localization without and HD map for sensor fusion in V2X. A LiDAR odometry module 510 includes inputs from a LiDAR 516, GPS 518 and an inertial measurement unit 520 outputting a signal to a fusion filter 514. A visual odometry unit 512 receives input from the IMU 522, GPS 524 and camera 526 and outputs a signal to the fusion filter 514. The fusion filter also receives input from the GPS 530 and a wheel encoder 528 to output a localization 534.

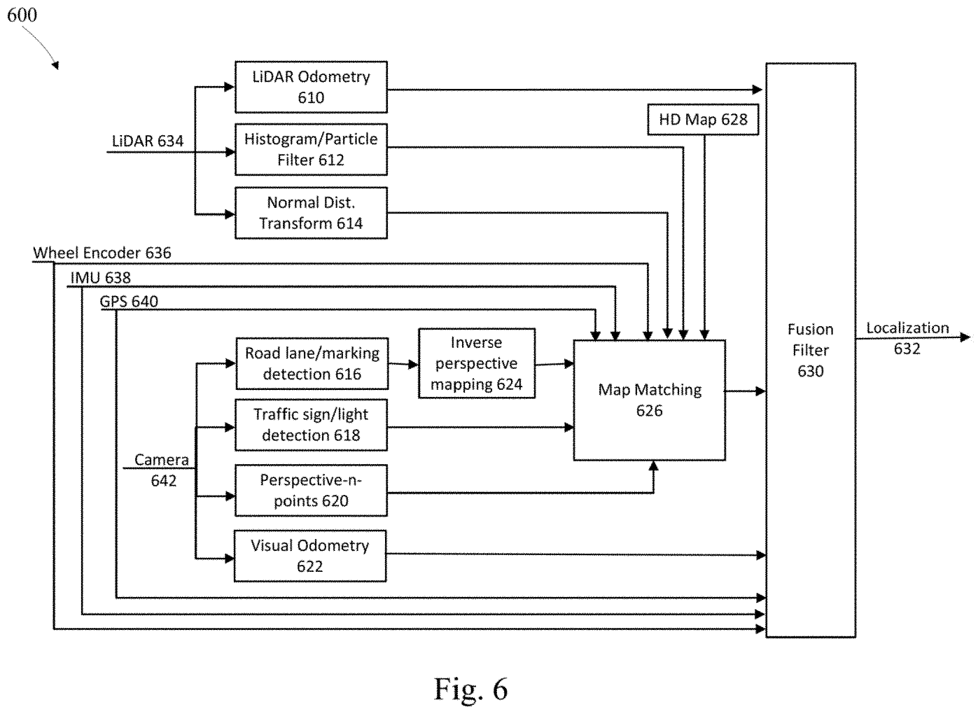

FIG. 6 illustrates a localization platform with an HD map, GPS and other odometry devices. HD Map matching may result in more accurate localization. Histogram/particle filter may be used for LiDAR reflectivity map-based matching and NDT (normal distribution transform) for LiDAR point cloud-based matching.

Camera sensor installed vehicles may be utilized for detection of landmarks like road lane/markings, traffic signs/lights, are identified and matched with the corresponding elements in HD Map for matching. IPM (inverse perspective mapping) may be utilized to convert landmark location in image plane to road plane for reasonable matching with HD Map. Traffic signs and lights in the HD Map may be projected onto the image plane for matching. PnP (perspective-n-points) may be utilized for 3-D point cloud matching with 2-D image feature points.

FIG. 6 depicts an example of vehicle localization with an HD map for sensor fusion in V2X. A LiDAR input 634 is received in a LiDAR odometry module 610, a histogram particle filter 612 and a normal distribution transform 614. Outputs from 610, 612 and 614 are received by a map matching module 626 concurrent with data from HD map module 628.

A camera inputs data 642 to a road lane and marking detection unit 616, a traffic sign and light detection unit 618, a perspective n points module 620 and visual odometry unit 622. The output from the road lane and marking detection unite 616 is received by inverse perspective mapping unit 624 which is then output to the map matching unit 626. The outputs of 618, 620 and 622 are also input to the map matching unit 626 in addition to the wheel encoder signal 636, the IMU 638 and the GPS 640.

The fusion filter 630 received LiDAR odometry data from module 610 and map matching data from 626 in addition to the wheel encoder signal 636, the IMU 638 and the GPS 640. The fusion filter outputting localization signal 632.

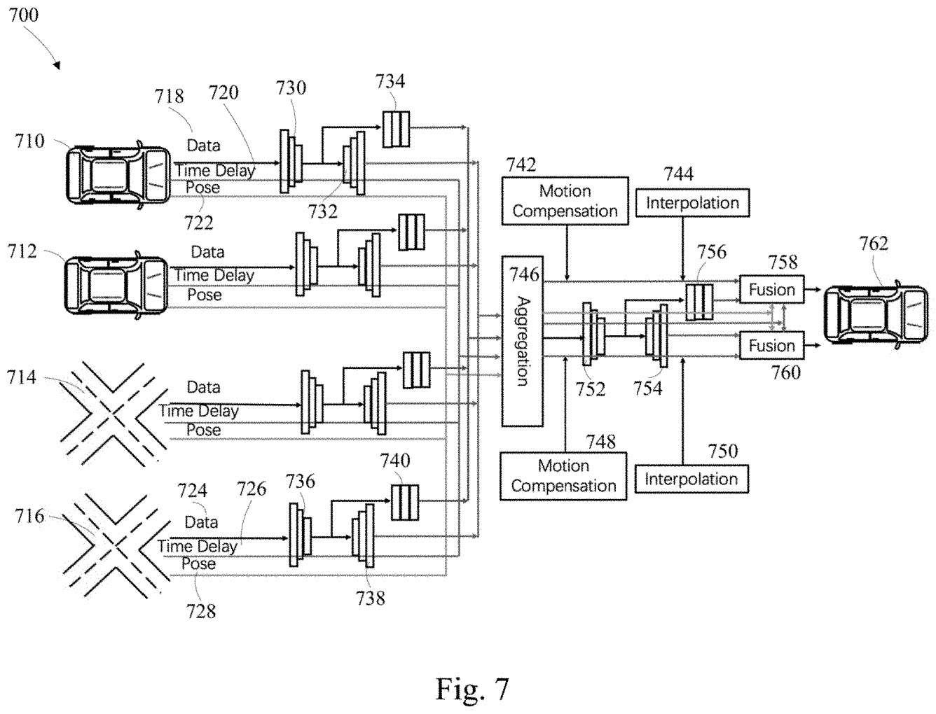

A neural network model may be utilized for information in a V2X framework, as shown in FIG. 7. From roadside and other vehicles' perception, the ego vehicle may receive more information about the road network and traffic rules, which may be integrated with its own perception to identify more confidently the driving environment. The local road network sends information pertaining to traffic rules, such lane merge, lane splits and ramps onto and off the highway, the locations of walkways, cross intersections, T-shaped intersections and roundabouts, and drivable spaces in non-urban environments. In addition data pertaining to traffic lights, stop/yield signs, speed limits, turn/straight arrows, traffic cones, warning for school areas, construction areas and the like may sent. Motion compensation and interpolation may align the detected landmarks and road markings with the ego vehicle.

This disclosure proposes a sensor fusion platform in V2X and a fusion network to combine information about raw data, IR and object level results together with the time delays and pose signals. The method may provide a localization framework in V2X to aide in collaborative perception.

FIG. 7 depicts an example of a road sensor network in V2X. Vehicles 710 and 712 output data 718 time delay 720 and pose 722 to an encoder 730, decoder 732 and fully connected layer 734 to be sent to the aggregation module 746. Roadway sensors 714 and 716 output data 724 time delay 726 and pose 728 to an encoder 736, decoder 738 and fully connected layer 740 to be sent to the aggregation module 746.

The aggregation module 746 is coupled to motion compensation modules 742 and 748, encoders 752, decoders 751 fully connection layer 756, interpolation modules 744 and 750 and fusion modules 758 and 760 forego vehicle 762.

FIG. 8 depicts an example method of autonomous driving collaborative sensing, including 810 receiving at least one sensor input. 812 determining a pose based on the at least one sensor input and synchronizing 814 the at least one sensor input to the pose. The method also includes transforming 816 the at least one sensor input, the pose and the synchronization, determining 818 an intermediate representation based on the transform, determining 820 an object extraction based on the transform, aggregating 822 the at least one sensor input, the intermediate representation and the object extraction and determining 824 a birds eye view of the aggregation.

The method may also include encoding the transform, decoding the transform and compressing the transform. The at least one sensor input may include at least one of a camera signal and a LiDAR signal. The method may also include receiving a high definition map of a region where the at least one sensor input is received, decompressing and interpolating the aggregation and motion compensating the aggregation, the intermediate representation and the object extraction. The at least one sensor input may be received from at least one of a proximate vehicle and a road side sensor and may include a LIDAR, a wheel encoder, an inertial measurement unit, a GPS and a camera.

FIG. 9 depicts another example method of autonomous driving collaborative sensing, including receiving 910 at least one sensor input, determining 912 a pose based on the at least one sensor input and synchronizing 914 the at least one sensor input to the pose. The method also includes transforming 916 the at least one sensor input, the pose and the synchronization, determining 918 an object extraction based on the transform and aggregating 920 the at least one sensor input and the object extraction. The method further includes detecting 922 the extracted object, segmenting 924 the extracted object, fusing 926 the detected and segmented object and determining 928 a birds eye view of the aggregation.

The method may also include encoding the transform, decoding the transform and compressing the transform. The at least one sensor input may include at least one of a camera signal and a LiDAR signal. The method may also include receiving a high definition map of a region where the at least one sensor input is received, decompressing and interpolating the aggregation and motion compensating the aggregation, the intermediate representation and the object extraction. The at least one sensor input may be received from at least one of a proximate vehicle and a road side sensor and may include a LiDAR, a wheel encoder, an inertial measurement unit, a GPS and a camera. The at least one sensor input may be received from at least one of a proximate vehicle and a road side sensor.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the system.

Skilled artisans may implement the described functionality in varying ways for each particular application. Various components and blocks may be arranged differently (e.g., arranged in a different order, or partitioned in a different way) without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects may be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code may be construed as a processor programmed to execute code or operable to execute code.

A phrase such as an “aspect” does not imply that such aspect is essential to the subject technology or that such aspect applies to configurations of the subject technology. A disclosure relating to an aspect may apply to configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to configurations of the subject technology. A disclosure relating to an embodiment may apply to embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to configurations of the subject technology. A disclosure relating to a configuration may apply to configurations, or one or more configurations. A configuration may provide one or more examples. A phrase such as a “configuration” may refer to one or more configurations and vice versa.

The word “example” is used herein to mean “serving as an example or illustration.” Any aspect or design described herein as “example” is not necessarily to be construed as preferred or advantageous over other aspects or designs.

Structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

References to “one embodiment,” “an embodiment,” “some embodiments,” “various embodiments”, or the like indicate that a particular element or characteristic is included in at least one embodiment of the invention. Although the phrases may appear in various places, the phrases do not necessarily refer to the same embodiment. In conjunction with the present disclosure, those skilled in the art may be able to design and incorporate any one of the variety of mechanisms suitable for accomplishing the above described functionalities.

It is to be understood that the disclosure teaches just one example of the illustrative embodiment and that many variations of the invention may easily be devised by those skilled in the art after reading this disclosure and that the scope of then present invention is to be determined by the following claims.

What is claimed is:

1. A method of autonomous driving collaborative sensing, comprising:
receiving at least one sensor input;
determining a pose based on the at least one sensor input;
synchronizing the at least one sensor input to the pose;
transforming the at least one sensor input, the pose and the synchronization;
determining an intermediate representation based on the transform;
determining an object extraction based on the transform;
aggregating the at least one sensor input, the intermediate representation and the object extraction; and
determining a birds eye view of the aggregation.

2. The method of autonomous driving collaborative sensing of claim 1, further comprising:
encoding the transform;
decoding the transform; and
compressing the transform.

3. The method of autonomous driving collaborative sensing of claim 1, wherein the at least one sensor input comprises at least one of a camera signal and a LiDAR signal.

4. The method of autonomous driving collaborative sensing of claim 1, further comprising receiving a high definition map of a region where the at least one sensor input is received.

5. The method of autonomous driving collaborative sensing of claim 1, further comprising decompressing and interpolating the aggregation.

6. The method of autonomous driving collaborative sensing of claim 1, further comprising motion compensating the aggregation, the intermediate representation and the object extraction.

7. The method of autonomous driving collaborative sensing of claim 1, wherein the at least one sensor input is received from at least one of a proximate vehicle and a road side sensor.

8. The method of autonomous driving collaborative sensing of claim 1, wherein the at least one sensor input is received from at least one of a LiDAR, a wheel encoder, an inertial measurement unit, a GPS and a camera.

9. A method of autonomous driving collaborative sensing, comprising:
receiving at least one sensor input;
determining a pose based on the at least one sensor input;
synchronizing the at least one sensor input to the pose;
transforming the at least one sensor input, the pose and the synchronization;
determining an object extraction based on the transform;
aggregating the at least one sensor input and the object extraction;
detecting the extracted object;
segmenting the extracted object;
fusing the detected and segmented object; and
determining a birds eye view of the aggregation.

10. The method of autonomous driving collaborative sensing of claim 9, further comprising:
encoding the transform;
decoding the transform; and
compressing the transform.

11. The method of autonomous driving collaborative sensing of claim 9, wherein the at least one sensor input comprises at least one of a camera signal and a LiDAR signal.

12. The method of autonomous driving collaborative sensing of claim 9, further comprising receiving a high definition map of a region where the at least one sensor input is received.

13. The method of autonomous driving collaborative sensing of claim 9, further comprising decompressing and interpolating the aggregation.

14. The method of autonomous driving collaborative sensing of claim 9, wherein the at least one sensor input is received from at least one of a proximate vehicle and a road side sensor.

15. The method of autonomous driving collaborative sensing of claim 9, wherein the at least one sensor input is received from at least one of a LiDAR, a wheel encoder, an inertial measurement unit, a GPS and a camera.
